(19) United States
(12) Patent Application Publication
(10) Pub. No.: US 2025/0068996 A1
(43) Pub. Date: Feb. 27, 2025

(54) System and Method for Automated Task Allocation

(71) Applicant: ZEBRA TECHNOLOGIES CORPORATION, Lincolnshire, IL (US)

(72) Inventors: Abdalkarim Mohtasib, Lincoln (GB); Yuling Gu, Lincolnshire, IL (US); Jay J. Williams, Glenview, IL (US); Bassam S Arshad, Wheeling, IL (US)

(21) Appl. No.: 18/237,961

(22) Filed: Aug. 25, 2023

(51) Int. Cl. G06Q 10/0631

(52) U.S. Cl. CPC G06Q 10/063112; G06Q 10/06316

(57) ABSTRACT

A method includes: obtaining task records defining tasks to be performed, and worker profiles corresponding to workers to perform the tasks; generating a bipartite sub-graph including: source nodes for the task records, each having a source feature vector encoding task attributes corresponding to the task record, a target node having a target feature vector encoding worker attributes corresponding to a first one of the worker profiles, and a set of edges connecting each source node with the target node, each edge having an edge feature vector derived by comparing the task attributes with the worker attributes; generating, via execution of a graph neural network, scores corresponding to the edges; based on the scores, allocating a first task to the first worker profile; and transmitting the task record corresponding to the first task to a client computing device corresponding to the first worker profile.

### BACKGROUND

The operation of facilities such as retailers, warehouses, and the like, may involve the performance of a wide variety of tasks by staff at such facilities. The variety of tasks and staff may render the allocation of tasks to staff members computationally challenging, resulting in suboptimal use of resources and/or performance of tasks within the facility.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for automated task allocation in a facility.

FIG. 2 is a diagram of certain internal components of the computing device of FIG. 1.

FIG. 3 is a flowchart of a method of automated task allocation.

FIG. 4 is a diagram illustrating an example performance of blocks 305 and 310 of the method of FIG. 3, and of an example bipartite graph.

FIG. 5 is a diagram illustrating an example performance of blocks 315 and 320 of the method of FIG. 3.

FIG. 6 is a diagram illustrating an example performance of block 325, and a further example performance of block 315 of the method of FIG. 3.

FIG. 7 is a diagram illustrating an example performance of block 335 of the method of FIG. 3.

FIG. 8 is a diagram illustrating an example performance of block 340 of the method of FIG. 3.

FIG. 9 is a flowchart of a method for performing block 305 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to method in a computing device, comprising: obtaining a plurality of task records defining tasks to be performed at a facility; obtaining a plurality of worker profiles corresponding to workers to perform the tasks; generating a bipartite sub-graph including: (i) a source node for each task record, each source node having a source feature vector encoding task attributes corresponding to the task record, (ii) a target node having a target feature vector encoding worker attributes corresponding to a first one of the worker profiles, and (iii) a set of edges connecting each source node with the target node, each edge having an edge feature vector derived by comparing the task attributes with the worker attributes; generating, via execution of a graph neural network, scores corresponding to the edges; based on the scores, allocating a first task to the first worker profile; and transmitting the task record corresponding to the first task to a client computing device corresponding to the first worker profile.

Additional examples disclosed herein are directed to a computing device, comprising: a communications interface; and a processor configured to: obtain a plurality of task records defining tasks to be performed at a facility; obtain a plurality of worker profiles corresponding to workers to perform the tasks; generate a bipartite sub-graph including: (i) a source node for each task record, each source node having a source feature vector encoding task attributes corresponding to the task record, (ii) a target node having a target feature vector encoding worker attributes corresponding to a first one of the worker profiles, and (iii) a set of edges connecting each source node with the target node, each edge having an edge feature vector derived by comparing the task attributes with the worker attributes; generate, via execution of a graph neural network, scores corresponding to the edges; based on the scores, allocate a first task to the first worker profile; and transmit, via the communications interface, the task record corresponding to the first task to a client computing device corresponding to the first worker profile.

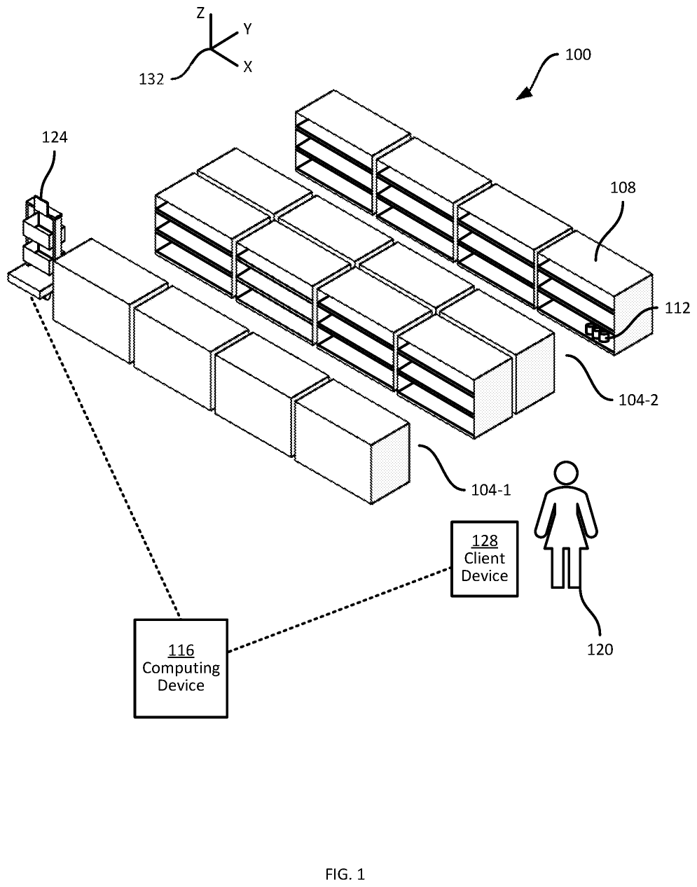

FIG. 1 illustrates a system 100 for automated task allocation in a facility, such as a retail facility (e.g., a grocer) containing one or more aisles 104-1, 104-2 (also referred to collectively as aisles 104, or generically as an aisle 104; similar nomenclature may also be employed herein for other elements with reference numbers with hyphenated suffixes). The aisles 104 can be formed, as in the illustrated example, by support structures such as shelf modules 108, each defining one or more support surfaces (e.g., shelves, peg boards, or the like) for supporting items 112 such as products available for purchase by customers of the retail facility. The system 100 can be deployed in a wide variety of other facilities, including manufacturing facilities, healthcare facilities, warehouses, and the like.

The system 100 includes a computing device 116 configured to obtain task records that define tasks to be performed in the facility, and to allocate the tasks to workers deployed in the facility to perform the tasks. The tasks can vary with the nature of the facility. For example, tasks allocated to workers in a retail facility as shown in FIG. 1 can include cleaning tasks (e.g., to clean a spill in an aisle 104), stock picking tasks to collect items 112 for order fulfillment, replenishment tasks to retrieve items 112 from a storage area (not shown) for placement on the shelf modules 108, and the like. The nature of the workers deployed in the facility to perform tasks may also vary between facilities. In the illustrated example, the workers can include either or both of human employees 120, and semi-or fully autonomous robots 124. Employees 120 can, for example, carry or otherwise access client computing devices 128, such as smart phones, tablet computers, or the like in communication with the computing device 116. The robots 124 can include on-board computing devices configured to communicate with the computing device 116.

Each of the robots 124 and the client devices 128 can track their locations in the facility, for example, according to a coordinate system 132 established in the facility. The client devices 128 and/or robots 124 can be configured to report tracked locations to the computing device 116, for use in task allocation functions performed by the computing device 116. In some examples, the system 100 can also include sensors such as wireless beacons or the like in communication with the computing device 116, that the computing device 116 can communicate with to determine locations of the client devices 128 and/or robots 124.

The computing device 116 is configured to receive task records defining tasks to be performed in the facility. The task records can be created, in some examples, by operators of the system 100 such as the workers mentioned above. For example, in response to detecting or otherwise becoming aware of a spill in an aisle 104, a manager of the facility, an employee 120, or the like, can submit a task record to the computing device 116, either via direct interaction with the computing device 116, or via a client device 128. The computing device 116 can be configured to transmit the task record to a worker, instructing the worker to perform the task (e.g., to travel to the relevant aisle 104 and clean the spill). The computing device 116 can also be configured to track the progress of a task once the task has been allocated to a worker, e.g., to determine a period of time elapsed between allocation of the task and receipt of an indication from the worker that the task is complete.

Facilities can have a wide variety of physical layouts and sizes, and may have tens, hundreds, or thousands of workers deployed therein at a given time. The tasks to be performed in the facility can vary in urgency, expected duration, skills required by the worker performing the tasks, and the like. Further, a number of tasks to be allocated and/or performed concurrently in a facility can also vary widely. In a retail facility such as a grocer, hundreds or thousands of tasks may be generated to be allocated and performed amongst a pool of workers over the course of a time period of several hours. Allocating the tasks to workers can be a complex undertaking, involving balancing numerous factors (e.g., task duration, a length of time a task has been awaiting allocation, task priority, task and worker locations, worker availability, and the like) to optimize the use of worker time, e.g., by minimizing worker travel distance and/or other factors.

The complexity of task allocation is, in some systems, addressed by human managers at the facility with sufficient experience to subjectively allocate tasks to workers. Attempts to automate task allocation, e.g., by rules-based algorithms such as decision trees and the like, can lead to suboptimal allocation, and may scale poorly as the number of tasks and workers increase. Such systems may also be limited to allocating tasks based on a small set of attributes (e.g., limited to task priority), as the consideration of additional attributes may increase the computational complexity and/or storage requirements for decision trees to impractical levels. Still further, systems with rules-based task allocation may be difficult to alter, e.g., to increase or decrease the importance of certain performance metrics (e.g., to reduce the time tasks spend awaiting allocation). Such systems may also be prone to network biases, e.g., disproportionately allocating tasks to specific workers based on an order in which the workers are listed in data records used for task allocation. The above difficulties may prevent automated task allocation, and/or lead to suboptimal use of worker time, delayed or failed allocation of certain tasks, and the like.

The computing device 116, as discussed below, performs various functions to automatically generate task allocations from the task records in a manner that is scalable to various numbers of tasks and workers. The task allocation functions performed by the computing device 116 can also mitigate network biases, and/or permit reconfiguration by operators of the system, e.g., to tune task allocation performance.

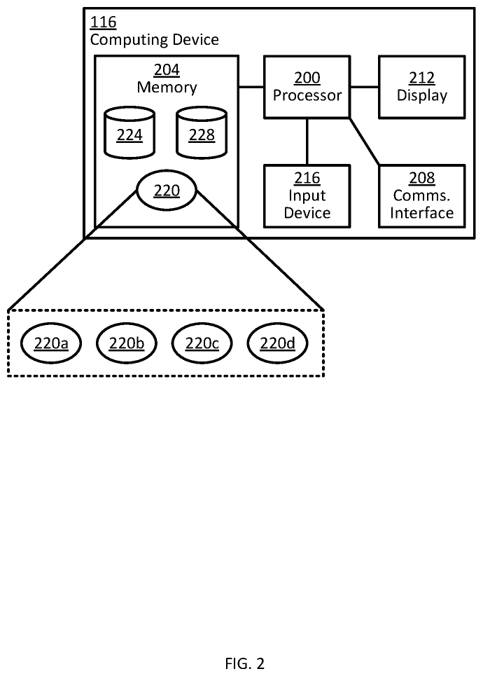

FIG. 2 is a diagram of certain internal components of the computing device 116. The computing device 116 includes a processor 200 (e.g., a central processing unit (CPU), graphics processing unit (GPU), and/or other suitable control circuitry, microcontroller, or the like), interconnected with a non-transitory computer readable storage medium, such as a memory 204. The memory 204 includes a suitable combination of volatile memory (e.g. Random Access Memory or RAM) and non-volatile memory (e.g. read only memory or ROM, Electrically Erasable Programmable Read Only Memory or EEPROM, flash memory). The memory 204 can store computer-readable instructions, execution of which by the processor 200 configures the processor 200 to perform various functions in conjunction with certain other components of the computing device 116. The computing device 116 also includes a communications interface 208 enabling the device 116 to exchange data with other computing devices, e.g. via a wireless local area network deployed in the facility, a combination of local and wide-area networks, and the like.

The device 116 can also include a display 212 and/or other suitable output device, such as a speaker, and an input device 216 such as a keyboard, a mouse, a microphone, and/or other suitable inputs. In other examples, the display 212 and input device 216 are hosted by a separate computing device (not shown), and connected to the computing device 116 via a network and the communications interface 208.

The components of the computing device 116 can be supported in a housing deployed at the facility of FIG. 1, e.g., as a desktop computer, on-site server, or the like. In other examples, the computing device 116 can be implemented in cloud infrastructure, e.g., as a virtual machine executed on computing hardware shared between various other functions.

The instructions stored in the memory 204 include, in this example, a task allocation application 220 that, when executed by the processor 200, configures the device 116 to obtain task records corresponding to tasks to be performed at the facility and worker profiles corresponding to workers deployed in the facility to perform tasks, and to allocate the tasks to the workers. The device 116 and the application 220 may be referred to in the discussion below to be configured to perform various actions. It will be understood that such references indicate that the device 116 is configured to perform those actions via execution of the application 220 by the processor 200.

In the illustrated example, the application 220 includes several components implementing various sets of functions, as discussed below. For example, the application 220 can include a failed allocation detector 220a, configured to determine when a task allocation has not been acknowledged by a worker and to prepare for re-allocation of that task. The application 220 can also include a completion detector 220b, configured to determine when certain tasks are likely to have been completed, even in the absence of explicit indications of completion from workers. The application 220 can further include a critical task handler 220c, configured to process certain tasks (e.g., tasks meeting priority criteria) according to dedicated rulesets that effectively bypass the primary task allocation functionality of the device 116. The application 220 further includes a primary task allocator 220d, configured to allocate a pool of tasks (e.g., an initial pool of unallocated tasks, modified by the actions of the detector 220a, the detector 220b, and the handler 220c) to a pool of workers. As discussed below, the allocator 220d implements a bipartite graph neural network (BGNN) to generate task allocations.

In some examples, the components of the application 220 can be implemented as distinct applications. In further examples, one or more of the components of the application 220 can be implemented via dedicated control hardware, such as an application-specific integrated circuit (ASIC) or the like.

The memory 204 can also store data employed during execution of the application 220 to allocate a task. As shown in FIG. 2, the memory 204 can store a task repository 224, containing task records that define tasks to be performed in the facility of FIG. 1 (or any other suitable facility). Data defining a task can include a task name or instruction (e.g., open a cashier aisle, clean a spill, restock an item 112, or the like), an expected task duration, and a task priority (e.g., from critical or high-priority to best-effort or low priority, traversing any suitable number of graduations). Other data defining a task can include skill requirements for performing the task (e.g., a forklift operator certification), a task location (e.g., coordinates in the system 132 and/or identifier of an aisle 104), and the like.

Any given task record can also contain metadata associated with the task, such as an identifier of a worker allocated to the task (if the task has been allocated), and/or timestamps indicating one or more of when the task was generated, when the task was allocated, when the task was completed, and the like. Other metadata that can be stored with a task can include a percentage or other fraction of completion of the task, e.g., obtained after the task has been allocated to a worker.

The memory 204 can also store a worker profile repository 228, containing worker profiles each corresponding to a worker in the facility. Each worker profile can include, for example, an identifier of the corresponding client device 128 (or of the worker itself, in the case of a robot 124). The identifier can include a network identifier such as an IP address, a media access control (MAC) address, an account name, or the like. Each worker profile can also include identifying information such as a name, as well as a worker skill set (e.g., certifications, authorization levels, and the like), and a worker location within the facility (which may be periodically updated). Each worker profile can also include an availability indicator, corresponding to whether or not the worker is currently performing a task. In some examples, a worker profile can include an activity indicator, corresponding to whether the worker (e.g., the client device 128, in the case of human workers 120) is online or offline. Worker profiles can also include timing information, such as a time remaining until the end of the worker's current shift in the case of an employee 120, and/or time remaining until a battery charging operation in the case of a robot 124. As discussed below, the computing device 116 is configured to generate graph data structures from the task records and the worker profiles, and process the graph data structures to allocate tasks to workers.

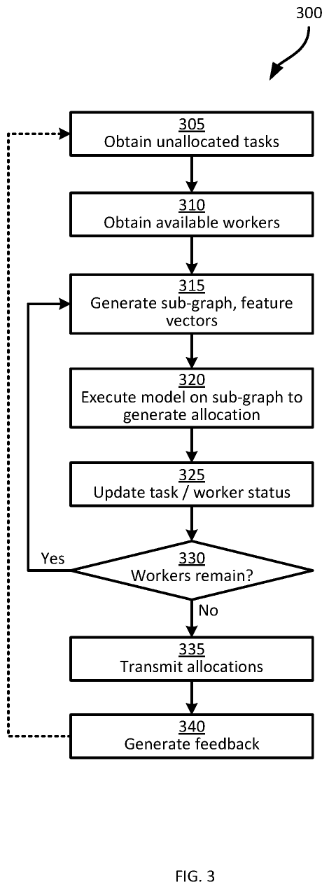

Turning to FIG. 3, a method 300 of automated task allocation is illustrated. The method 300 is described below in conjunction with its performance by the device 116, via execution of the application 220 by the processor 200.

At block 305, the device 116 is configured to obtain a plurality of task records each defining a task to be performed at the facility. The task records obtained at block 305, e.g., from the repository 224, define unallocated tasks, e.g., tasks that have not yet been allocated to a worker to be performed by that worker. Task records can be generated within the repository 224 in response to input data received at the device 116 (e.g., via the input device 216), and/or in response to messages received at the device 116 from other computing devices, defining tasks to be performed in the facility. The task records are created without allocated workers, and workers are allocated to tasks via performance of the method 300. The records retrieved at block 305 can therefore include task records that have not been allocated since their creation. In some examples, however, as described further below, the computing device 116 can perform various preprocessing operations on the records of the repository 224, to return some task records from an allocated state to an unallocated state, for example. In such examples, the records obtained at block 305 are those remaining unallocated after such preprocessing.

Each task record defines attributes of a corresponding task. For example, a task to open a cashier aisle in a retail facility can include a task identifier (e.g., a number, an alphanumeric string, or the like), and a task name and/or instruction (e.g., a plain language string conveying the nature of the task to the worker to whom the task is later allocated). The task record can include additional attributes such as a priority level (e.g., selected from a range such as low, medium, high, and critical, although a wide variety of other priority metrics can also be employed), a task location (e.g., expressed as coordinates in the system 132). Other example attributes in the task record can include an expected task duration. The task record can further include metadata attributes such as a time when the task record was created and/or a time when the task record was most recently queued for allocation (which may be different from the time of creation, e.g., if the task record was previously allocated but returned to an unallocated state). Further example task attributes defined in the task record can include a skill set required for completion of the task. The skill set attribute can include selected ones of predefined skill identifiers, such as an identifier corresponding to a forklift certification, an identifier corresponding to a managerial access level, or the like.

At block 310, the computing device 116 is configured to obtain a plurality of worker profiles corresponding to workers available to perform the tasks obtained at block 305. The worker profiles can be retrieved from the repository 228, which maintains profiles of each worker at the facility (e.g., each employee 120 of the facility). Each worker profile can include various worker attributes, including names, addresses, ages, genders, and the like. Worker profiles can also include attributes such as an availability indicator, which can be a binary indication of whether the worker currently has a task allocated to them (e.g., that is still in progress). The availability indicator can be, for example “busy” or “available”, although a wide variety of other indicators can also be employed. The worker profile can also include a presence indicator, such as “online” or “offline”, indicating whether the client device 128 associated with the worker is in communication with a network deployed within the facility. The worker attributes defined in the worker profile can further include a current location of the worker, e.g., updated periodically via the sensors mentioned previously, or by reporting from the corresponding client device 128. The worker profile can also include an identifier of the worker, such as a number, an alphanumerical string, or the like, and an identifier of the corresponding client device 128, such as the IP address or MAC address noted earlier. Still further, example worker attributes can include a time remaining until the worker's current shift ends.

At block 315, the device 116 is configured to generate a bipartite sub-graph including a source node for each of the unallocated task records obtained at block 305, and a target node for one of the worker records obtained at block 310. A bipartite graph is a graph whose nodes can be divided into two independent sets (tasks and workers, in this case). The edges of the graph connect nodes in one set with nodes in the other. Thus, in this example, each edge in the bipartite graph connects one task with one worker. The sub-graph generated at block 315 is referred to as a sub-graph because, rather than representing the full set of tasks and workers, the sub-graph represents at least a portion of the tasks (up to the full set, for at least the initial performance of block 315), but only one worker. The generation and subsequent processing of a sub-graph at block 315 is iterated, as discussed below, until an allocation has been determined for each worker.

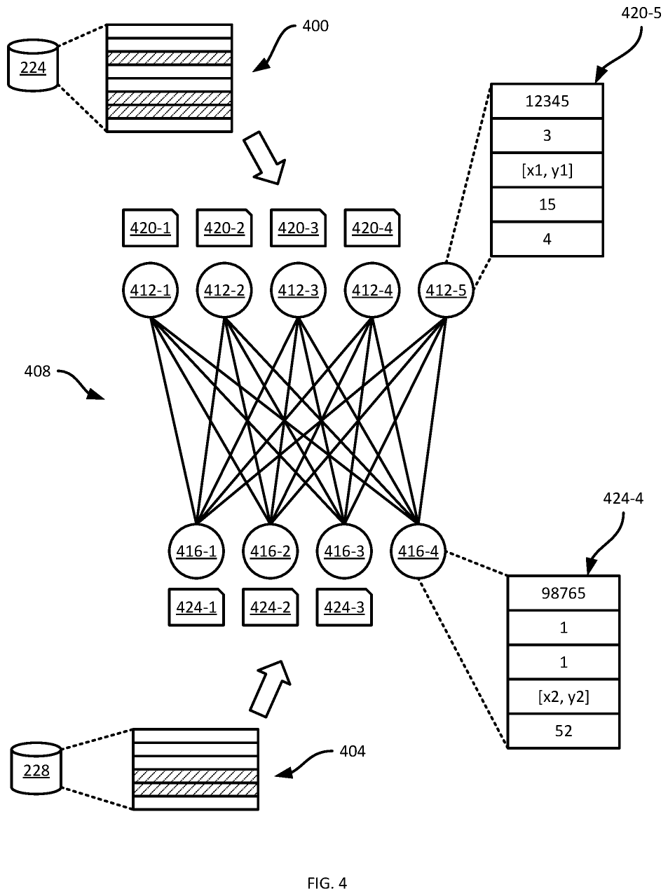

Turning to FIG. 4, an example illustration of blocks 305 and 310 is shown, as well as an example bipartite graph from which the sub-graph at block 315 may be extracted, although it is also contemplated that the device 116 can generate the sub-graph in isolation, without first generating the full graph. Generation of the sub-graph alone may be computationally more efficient, as the results of processing one sub-graph can affect the construction of subsequent sub-graphs, and pre-generating the entire graph initially may therefore be unnecessary.

FIG. 4 illustrates the repositories 224 and 228, with sets of example task records 400 and worker profiles 404. The task records 400 corresponding to tasks that have already been allocated are shown with hatched fills, as are the worker profiles 404 corresponding to workers that are either offline (e.g., not on shift, whose client devices 128 are disconnected, or the like), or busy (e.g., already performing a previously allocated task). At block 305, the device 116 retrieves only the white-filled task records 400, and at block 310, the device 116 retrieves only the white-filled worker profiles 404. FIG. 4 also illustrates a bipartite graph 408 representing the retrieved task records and worker profiles, although the device 116 need not generate the entire graph at block 315. The graph 408 includes source nodes 412-1, 412-2, 412-3, 412-4, and 412-5 corresponding to the retrieved task records 400, and target nodes 416-1, 416-2, 416-3, and 416-4 corresponding to the retrieved worker profiles 404. The source nodes 412 have corresponding feature vectors 420-1, 420-2, 420-3, 420-4, and 420-5, encoding at least a portion of the task attributes defined in the task records 400. The target nodes 416 have corresponding feature vectors 424-1, 424-2, 424-3, and 424-4, encoding at least a portion of the worker attributes defined in the worker profiles 404.

Each node 412 is interconnected with all the nodes 416 by respective edges. The edges also have corresponding feature vectors, but the device 116 need not generate the edge feature vectors at block 315. In some examples, at block 315 the device 116 can generate each of the nodes 412 and 416, and the corresponding feature vectors 420 and 424, but can generate only a portion of the edges shown in FIG. 4, depending on the sub-graph being generated.

Example contents of the feature vector 420-5 is illustrated, including a task identifier “12345” used to distinguish the corresponding task record from other task records, a priority level (e.g., with “3” indicating “high” on the range mentioned earlier), a location expressed in coordinates in the system 132, an expected task duration, e.g., in minutes, and a current queue time representing the length of time the task record has been awaiting allocation. The feature vector 420-5 can also encode other attributes, such as a skill set, or the like. The attributes encoded in the feature vectors 420 are numerical, for subsequent processing via a neural network. The device 116 can therefore convert non-numerical task data such as a priority level of “high”, to a numerical value based on a predetermined mapping, via one-hot encoding, or the like. The feature vectors 420 can also each include shared attributes such as a current average expected task duration across all nodes 412, an average priority value across all nodes 412, an average queue time (e.g., the time tasks have been awaiting allocation), and the like.

Example contents of the feature vector 424-4 is also illustrated. As shown in FIG. 4, the feature vector 424-4 includes a worker identifier (e.g., an employee number or the like), an availability state (e.g., with “1” indicating available and “0” indicating busy), a presence state (e.g., with “1” indicating online and “0” indicating offline), a current location, and a time remaining until the worker ends their shift, e.g., in minutes. The feature vectors 424 can also include other attributes, such as skill sets for the corresponding workers (e.g., one-hot encoded or the like), and/or the shared task attributes noted above. In other examples, the feature vectors 420 and 424 can include other data, such as traffic, weather, or the like, e.g., retrieved by the device 116 contemporaneously with blocks 305 or 310 from external data sources.

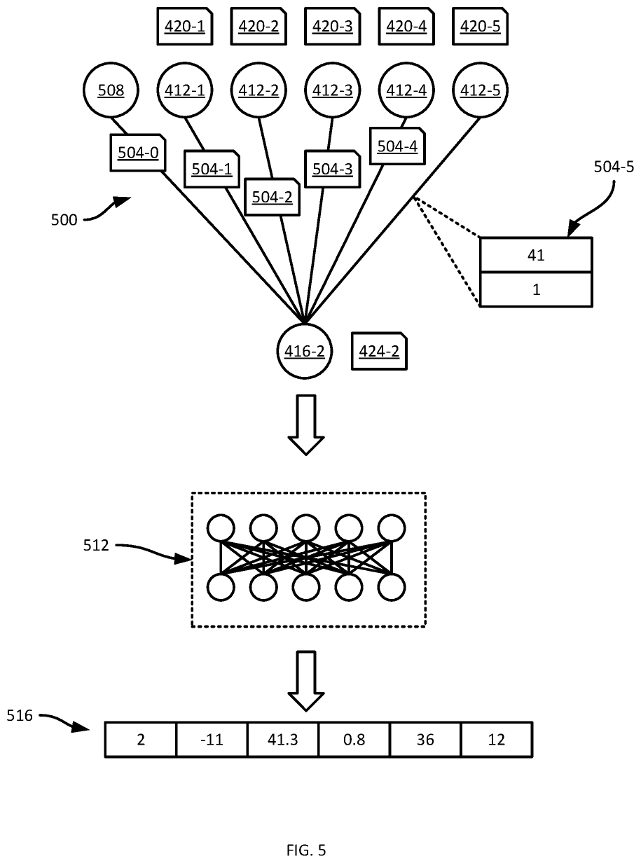

Turning to FIG. 5, an example illustration of block 315 is illustrated. The device 116 is configured to select one of the worker records obtained at block 310. In examples in which the device 116 generates each of the target nodes 416 prior to block 315, the device 116 can select one of the target nodes 416. For example, the device 116 can select a worker/target node 416 at random from the worker profiles obtained at block 310. Random selection of a worker at block 315 can mitigate network bias effects that may otherwise result, for example, in workers with identifiers that sort higher in alphabetical and/or numerical lists being assigned tasks more frequently.

Having selected the target node 416 (the target node 416-2 in this example), or selected a worker and generated the corresponding target node 416, the device 116 is configured to generate the corresponding sub-graph 500 by generating the source nodes 412 if they were not already generated, and also generating feature vectors 504-1, 504-2, 504-3, 504-4, and 504-5 for edges connecting the source nodes 412 to the target node 416-2. Each feature vector 504 includes attributes derived by comparing the task attributes of a source node 412 with the worker attributes of the selected target node 416. Example contents of the feature vector 504-5 is illustrated in FIG. 5, including for example a distance (e.g., in meters) between the task location specified in the feature vector 420-5 and the worker location specified in the feature vector 424-2. The feature vector 504-5 can also include an indication, e.g., a binary indication, or whether the expected duration from the feature vector 420-5 is smaller than the remaining availability time of the selected worker. Various other attributes can also be included in the feature vector 504-5, such as a binary indication of whether the skill set requirement of the corresponding task is met by the skill set of the selected worker.

The device 116 can also generate, as a component of the sub-graph 500, an additional source node 508, also referred to as a skip node. The skip node 508 may omit a feature vector, or may include a null feature vector. The device 116 can be configured to generate an edge feature vector 504-0 connecting the skip node 508 with the target node 416-2. The feature vector 504-0 can contain null values, for example. The skip node 508 represents a non-allocation of tasks to the worker corresponding to the target node 416-2. That is, the skip node 508 provides the device 116 with the option of not allocating any task to a given worker, e.g., to enable certain workers in the system 100 to remain available for performing high-importance tasks (e.g., tasks that are allocated substantially immediately upon generation, via a distinct process from that performed with the sub-graph 500).

Returning to FIG. 3, at block 320, the computing device 116 is configured to execute a bipartite graph neural network (BGNN) on the sub-graph generated at block 315, to generate a score, weight, or the like, corresponding to each of the edges of the sub-graph 500. At block 320, the sub-graph 500 is provided as an input to the BGNN, e.g., by generating input data for the BGNN that includes the feature vectors 420, 504, and 424-2 along with data indicating the connections between the nodes corresponding to those feature vectors. As shown in FIG. 5, a BGNN 512 implemented by the allocator 220d can include a deep neural network with one or more hidden layers (e.g., two layers are shown in the illustrated example, but the BGNN 512 can include additional hidden layers in other examples) having any suitable number of nodes. The BGNN is configured to generate, as output, a set of scores 516 corresponding to the edge feature vectors 504-0, 504-1, 504-2, 504-3, 504-4, and 504-5. The scores can represent a strength of association between a source node 412 and the target node 416-2, for example, with higher values indicating stronger associations. The device 116 is configured, at block 320, to allocate a task to the target node 416-2 based on the scores 516. Task allocation can include a greedy selection, e.g., selecting the source node with the highest score (e.g., the source node 412-2, in this example, with a score of 41.3). In other examples, task allocation can include generating a probability distribution from the scores 516, e.g., via a SoftMax operation, and sampling the probability distribution (which is likely to, but will not necessarily, result in the source node 412-2 being allocated in this example performance of block 320).

Returning to FIG. 3, at block 325 the device 116 can be configured to update one or more status indicators for the worker processed at block 320, and the task allocated to the worker (unless the skip node was selected at block 320). For example, the task record 400 corresponding to the source node 412-2 can be updated to include a worker identifier corresponding to the target node 416-2, reflecting that the task has been allocated. The worker profile 404 corresponding to the target node 416-2 can also be updated, e.g., to indicate that the corresponding worker is now busy rather than available, and optionally to include a task identifier of the task allocated to the corresponding worker. Updating task and/or worker status at block 325 can also include, for example, removing the target node 416-2 and the source node 412-2 from the graph 408, or otherwise excluding those nodes from future performances of block 315.

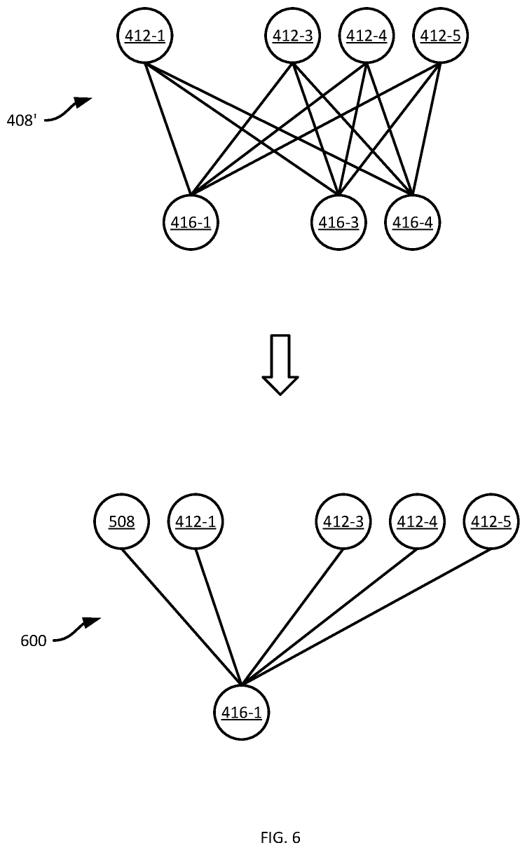

At block 330, the device 116 is configured to determine whether any workers from block 310 remain to be processed. In this example, the determination at block 330 is affirmative, and the device 116 therefore returns to block 315, to generate a further sub-graph for another selected target node 416, e.g., randomly selected from the target nodes 416-1, 416-3, and 416-4. Turning briefly to FIG. 6, an updated bipartite graph 408′ is illustrated, with the nodes 412-2 and 416-2 removed to reflect the allocation of the task corresponding to the source node 412-2 to the worker corresponding to the target node 416-2. At the next performance of block 315, the device 116 may select, for example, the target node 416-1, and generate a sub-graph 600 including the remaining source nodes 412-1, 412-3, 412-4, and 412-5, as well as the skip node 508. The sub-graph 600 is then processed via block 320 as described above. The generation of sub-graphs and allocation of tasks to workers via blocks 315, 320, and 325 continues until the determination at block 330 is affirmative. In response to an affirmative determination at block 330, the device 116 proceeds to block 335.

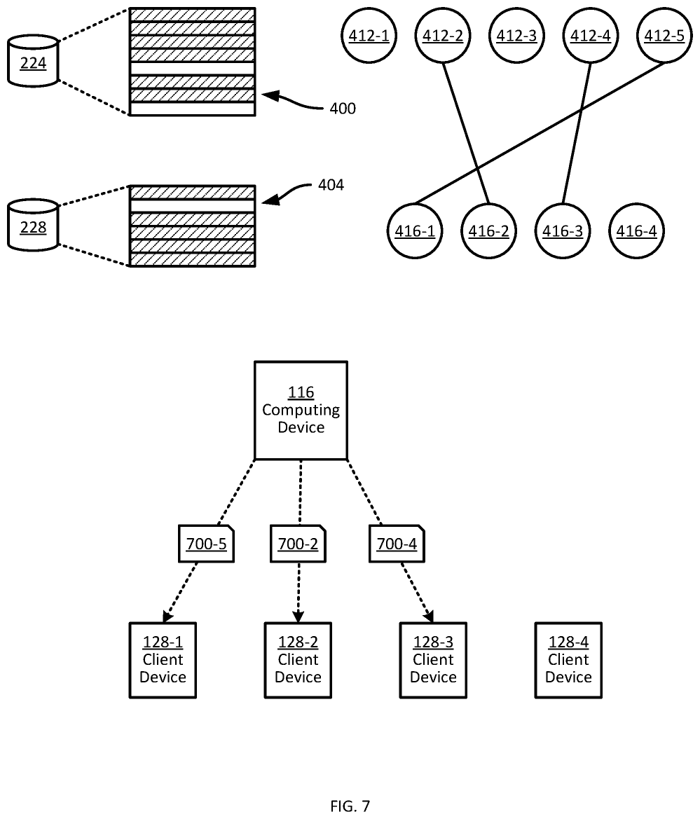

At block 335, the device 116 is configured to transmit the task allocations from successive performances of block 320 to the relevant workers, e.g., by sending messages to the corresponding client devices 128 containing information from the task records 400. For example, turning to FIG. 7, the final allocations upon an affirmative determination at block 330 can include the task corresponding to the source node 412-2 being allocated to the worker corresponding to the target node 416-2, the source node 412-4 being allocated to the target node 416-3, and the source node 412-5 being allocated to the target node 416-1. The worker corresponding to the target node 416-4 does not have an allocation, e.g., because the BGNN 512 selected the skip node 508 at block 320 for the target node 416-4. Additionally, the repositories 224 and 228 can be updated to reflect the allocations in certain task records 400 and certain worker profiles 404 (e.g., by indicating that certain tasks have been allocated, and by indicating that certain workers are busy).

As a result, two tasks, corresponding to the source nodes 412-1 and 412-3, remain unallocated. Those tasks, and/or any newly created tasks, can be processed via a future performance of the method 300. For example, the device 116 can be configured to initiate a performance of the method 300 at a predetermined frequency (e.g., once every ten minutes, although a wide variety of other frequencies are also contemplated), and/or in response to certain events. For example, the device 116 can initiate a performance of the method 300 when a number of tasks awaiting allocation reaches a threshold number.

FIG. 7 illustrates an example performance of block 335, e.g., in which the computing device 116 sends a message 700-5 (containing data for the task corresponding to the source node 412-5) to a client device 128-1 (corresponding to the worker that matches the target node 416-1), a message 700-2 to a client device 128-2, and a message 700-4 to a client device 128-3. As shown in FIG. 7, no message is sent to a client device 128-4 corresponding to the target node 416-4, as the performance of block 320 for the target node 416-4 resulted in selection of the skip node 508 for the target node 416-4.

The client devices 128 can be configured to present (e.g., via displays and/or other output devices) the task allocations defined in the messages 700 to their operators (e.g., workers such as employees 120), and/or prompt the operators to accept the allocated tasks. Upon acceptance, each client device 128 can be configured to send an acceptance message to the computing device 116, which can store an acceptance indication in conjunction with the corresponding task record 400.

Referring again to FIG. 3, in some examples the computing device 116 can await the initiation of a further performance of the method 300 after block 335. In the present example, however, the computing device 116 is configured, at block 340, to generate feedback data for the BGNN 512, prior to await the initiation of a further performance of the method 300. For example, the BGNN 512 can implement a reinforcement feedback process, by which the weights and/or other parameters of the nodes in the hidden layers shown in FIG. 5 can be adjusted in response to feedback data from block 340.

The feedback data generated, e.g., by the allocator 220d, at block 340 can include reward or penalty functions that compare one or more metrics from the set of allocations generated and transmitted at block 335 to corresponding metrics from a previous set of allocations (e.g., from the preceding performance of the method 300). For example, the allocator 220d can be configured, for each set of allocations generated, to determine a total travel distance for workers to arrive at their respective task locations. Based on a comparison of the current total travel distance and a previous total travel distance, the allocator 220d can determine a reward or penalty, e.g., a reward in the form of a numerical value that is lower if the total travel distance has increased, and higher if the total travel distance has decreased. The reward or penalty is applied to the BGNN as feedback data at block 340, and may alter the behavior of the BGNN in future performances of the method 300 to emphasize minimized travel distance.

The allocator 220d can generate a plurality of rewards or penalties at block 340, for a wide variety of metrics obtained by comparing current allocation results to previous allocation results. For example, metrics that can be employed to determine feedback data at block 340 can include any one or more of total queue time (e.g., time tasks awaited allocation), an average queue time, a total number of tasks allocated per day, and the like. Some feedback data can be specific, e.g., to certain priority levels, such as a metric indicating the average queue time for critical-priority tasks (with a reward function that rewards minimizing that average queue time).

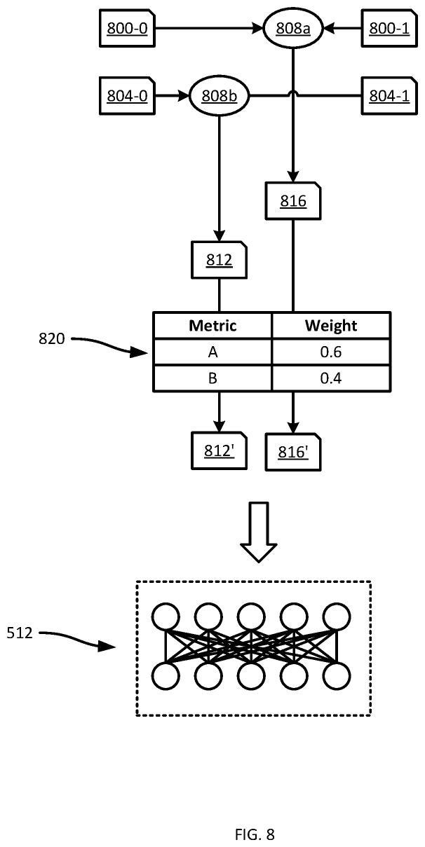

The allocator 220d can apply weighting factors to the above-mentioned metrics, e.g., to increase the impact on the BGNN 512 of one reward relative to others. The weighting factors applied to rewards or penalties can further be configurable, e.g., by a manager of the facility or the like via a client computing device 128, or via direct input at the computing device 116. Referring to FIG. 8, an example feedback generation mechanism is illustrated. In this example, metrics 800-0 (e.g., a total travel distance) and 804-0 (e.g., an average queue time for critical tasks) were determined from a previous performance of the method 300, and metrics 800-1 and 804-1 were determined from a current performance of the method 300. In other words, the metrics 800-0 and 804-0 represent a previous state, and the metrics 800-1 and 804-1 represent a current state. The allocator 220d can implement a first reward function 808a configured to generate feedback 816 such as a reward based on a comparison of the metrics 800, and a second reward function 808b configured to generate feedback 812 such as a reward based on a comparison of the metrics 804. The allocator 220d can implement additional metrics and/or reward functions 808, in other examples.

Before updating the BGNN 512 with the feedback 812 and 816, the allocator 220d can be configured to weight the feedback 812 and 816 according to configurable weighting factors 820, e.g., a weighting factor of 0.6 for the feedback 816, and a weighting factor of 0.4 for the feedback 812. Weighted feedback 812′ and 816′ is provided to the BGNN 512 for reinforcement training.

A wide variety of other weighting factors can be employed, and the weighting factors need not sum to a value of one in other examples. The weighting factors 820 are configurable, e.g., by operator input as mentioned above, permitting the behavior of the BGNN 512 to be modified over time. The reinforcement learning process noted above can also be used to train the BGNN 512 initially, e.g., iterating based on simulated tasks and workers.

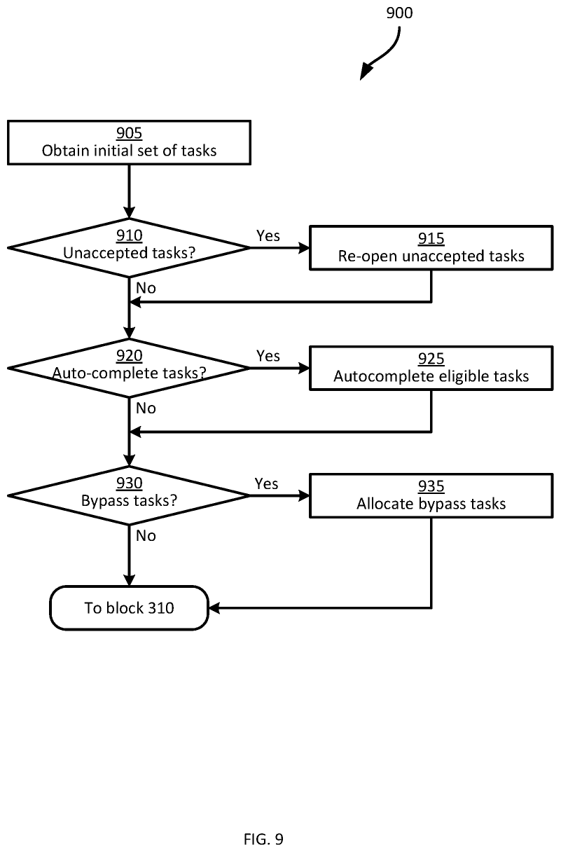

Turning to FIG. 9, a method 900 of performing block 305 of the method 300 is illustrated. In brief, performance of the method 900 by the device 116, e.g., by one or more of the failed allocation detector 220a, the completion detector 220b, and the critical task handler 220c, permits the device 116 to re-allocate previously allocated tasks under some conditions, to automatically alter the availability of some workers under some conditions, and/or to allocate certain tasks prior to processing via the BGNN 512.

At block 905, the device 116 is configured to obtain an initial set of task records from the repository 224. The initial set can include not only task records that have not yet been allocated, but also task records that have been allocated but not yet acknowledged by client devices 128, and task records that have been allocated and acknowledged, but not yet completed (e.g., for which the device 117 has not yet received an indication from a client device 128 that the task is complete).

At block 910, the failed allocation detector 220a can be configured to determine whether any allocated but not yet accepted tasks were allocated more than a threshold time period in the past. An allocated but not yet accepted task includes a task record with a worker identified as having been allocated to the task, but lacking a timestamp or other indication that the device 116 has received acceptance of the task allocation from the client device 128 corresponding to the allocated worker. The threshold time period can be configured, and serves to avoid an allocated task remaining uncompleted if the worker to whom the task was allocated fails to notice the allocation, for example. If the determination at block 910 is affirmative, the detector 220a proceeds to block 915, and re-opens the task by removing the allocation, so that the task will be processed in the upcoming instance of the method 300. The detector 220a can also update the status of the corresponding worker, e.g., from busy to available.

Following block 915, or a negative determination at block 910, at block 920 the completion detector 220b is configured to determine whether any of the tasks in the initial set from block 905 have been allocated and accepted, but not yet completed. For each such task, the detector 220b is configured to determine whether to automatically mark the task complete, in the absence of an indication from a client device 128 or other source that the task has been completed. The determination of whether to automatically mark a task complete can be based on various factors, including whether the task was allocated at least a threshold time period ago (e.g., an absolute amount of time, or a percentage of the expected task duration, such as 120%). For example, some task records can include an attribute such as an auto-completion eligibility indicator that explicitly defines whether the task can be automatically marked complete. In other examples, the detector 220b can implement one or more criteria to determine whether to automatically mark a task complete. For example, tasks may only be eligible for auto-completion if their priority levels are below a threshold (e.g., medium-priority or lower).

When the determination at block 920 is affirmative for any tasks from the initial set, the detector 220b is configured, at block 925, to mark those tasks complete, removing them from the set of tasks to be allocated via the method 300. The detector 220b can also update the availability status of the corresponding worker(s), e.g., from busy to available.

Following block 925, or a negative determination at block 920, at block 930 the critical task handler 220c is configured to determine whether the initial set from block 905 contains any bypass tasks. A bypass task can be, for example, a task with a priority level above a predetermined threshold, such as “critical”. Such tasks may bypass the allocation process implemented with the BGNN 512, and may instead be allocated substantially immediately. The method 900, in other words, can be repeated more frequently than the remainder of the method 300, e.g., in response to the creation of any critical-priority task.

When the determination at block 930 is affirmative, at block 935 the handler 220c can allocate any bypass tasks to workers, prior to the remainder of the method 300. Allocating bypass tasks at block 935 can be conducted using a rules-based approach that prioritizes speed of allocation and completion. For example, at block 935 the device 116 can be configured to allocate a critical-priority task to the nearest online worker (that is, with the location closest to the location of the task), regardless of whether that worker is busy or available. If a bypass task is allocated to a worker with an active allocation, the interrupted task can be returned to the pool of unallocated tasks to be processed via the remainder of the method 300. Once any bypass tasks have been allocated, the device 116 can proceed to block 310.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
obtaining a plurality of task records defining tasks to be performed;
obtaining a plurality of worker profiles corresponding to workers to perform the tasks;
generating a bipartite sub-graph including:
(i) a source node for each task record, each source node having a source feature vector encoding task attributes corresponding to the task record,
(ii) a target node having a target feature vector encoding worker attributes corresponding to a first one of the worker profiles, and
(iii) a set of edges connecting each source node with the target node, each edge having an edge feature vector derived by comparing the task attributes with the worker attributes;
generating, via execution of a graph neural network, scores corresponding to the edges;
based on the scores, allocating a first task to the first worker profile; and
transmitting the task record corresponding to the first task to a client computing device corresponding to the first worker profile.

2. The method of claim 1, further comprising: generating a second bipartite sub-graph including:
(i) a subset of the source nodes omitting the first task,
(ii) a second target node having a second target feature vector encoding worker attributes corresponding to a second one of the worker profiles, and
(iii) a second set of edges connecting each of the subset of source nodes with the second target node;
generating, via execution of the bipartite graph neural network, scores corresponding to the second set of edges;
based on the scores, allocating a second task to the second worker profile; and
transmitting the task record corresponding to the second task to a second client computing device corresponding to the second worker profile.

3. The method of claim 1,
wherein the task attributes include at least one of:
a priority level,
a duration,
a queue time,
a required skill set, or
a task location; and
wherein the worker attributes include at least one of:
a worker location,
an availability indicator,
a worker skill set, or
an availability time.

4. The method of claim 1, further comprising: prior to generating the bipartite sub-graph, selecting the first worker profile at random from the worker profiles.

5. The method of claim 1, wherein obtaining the plurality of task records includes:
obtaining a set of unallocated task records;
determining that a threshold time period has elapsed since transmission of a previously allocated task record, without receipt of a corresponding acceptance indicator; and
adding the previously allocated task record to the unallocated task records.

6. The method of claim 1, wherein obtaining the plurality of worker profiles includes:
obtaining a set of worker profiles with available status indicators;
determining that a threshold time period has elapsed since acceptance of a task record previously allocated to one of the worker profiles; and
adding the one of the worker profiles to the set of worker profiles with available status indicators.

7. The method of claim 1, wherein obtaining the plurality of task records includes:
obtaining a set of unallocated task records;
determining that an unallocated task record of the set meets a priority criterion; and
allocating the unallocated task record to a worker profile, and omitting the unallocated task record from the plurality of task records.

8. The method of claim 1, further comprising:
receiving input data defining a configurable weighting factor corresponding to a reinforcement learning metric;
determining a reward based on the weighting factor; and
updating the graph neural network based on the reward.

9. A computing device, comprising:
a communications interface; and
a processor configured to:
obtain a plurality of task records defining tasks to be performed;
obtain a plurality of worker profiles corresponding to workers to perform the tasks;
generate a bipartite sub-graph including:
(i) a source node for each task record, each source node having a source feature vector encoding task attributes corresponding to the task record,
(ii) a target node having a target feature vector encoding worker attributes corresponding to a first one of the worker profiles, and
(iii) a set of edges connecting each source node with the target node, each edge having an edge feature vector derived by comparing the task attributes with the worker attributes;
generate, via execution of a graph neural network, scores corresponding to the edges;
based on the scores, allocate a first task to the first worker profile; and
transmit, via the communications interface, the task record corresponding to the first task to a client computing device corresponding to the first worker profile.

10. The computing device of claim 9, wherein the processor is further configured to:
generate a second bipartite sub-graph including:
(i) a subset of the source nodes omitting the first task,
(ii) a second target node having a second target feature vector encoding worker attributes corresponding to a second one of the worker profiles, and
(iii) a second set of edges connecting each of the subset of source nodes with the second target node;
generate, via execution of the bipartite graph neural network, scores corresponding to the second set of edges;
based on the scores, allocate a second task to the second worker profile; and
transmit the task record corresponding to the second task to a second client computing device corresponding to the second worker profile.

11. The computing device of claim 9,
wherein the task attributes include at least one of:
a priority level,
a duration,
a queue time,
a required skill set, or
a task location; and
wherein the worker attributes include at least one of:
a worker location,
an availability indicator,
a worker skill set, or
an availability time.

12. The computing device of claim 9, wherein the processor is further configured to:
prior to generating the bipartite sub-graph, select the first worker profile at random from the worker profiles.

13. The computing device of claim 9, wherein the processor is configured to obtain the plurality of task records by:
obtaining a set of unallocated task records;
determining that a threshold time period has elapsed since transmission of a previously allocated task record, without receipt of a corresponding acceptance indicator; and
adding the previously allocated task record to the unallocated task records.

14. The computing device of claim 9, wherein the processor is configured to obtain the plurality of worker profiles by:
obtaining a set of worker profiles with available status indicators;
determining that a threshold time period has elapsed since acceptance of a task record previously allocated to one of the worker profiles; and
adding the one of the worker profiles to the set of worker profiles with available status indicators.

15. The computing device of claim 9, wherein the processor is configured to obtain the plurality of task records by:
obtaining a set of unallocated task records;
determining that an unallocated task record of the set meets a priority criterion; and
allocating the unallocated task record to a worker profile, and omitting the unallocated task record from the plurality of task records.

16. The computing device of claim 9, wherein the processor is further configured to:
receive input data defining a configurable weighting factor corresponding to a reinforcement learning metric;
determine a reward based on the weighting factor; and
update the graph neural network based on the reward.
